(19) United States
(12) Patent Application Publication
(10) Pub. No.: US 2007/0291962 A1
(43) Pub. Date: Dec. 20, 2007

(54) AUTOMOTIVE BALANCED MICROPHONE SYSTEM AND METHOD OF FORMING SAME

(76) Inventors: Alan R. Watson, Buchanan, MI (US); Robert R. Turnbull, Holland, MI (US); William R. Spence, Holland, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/753,994

(22) Filed: May 25, 2007

Related U.S. Application Data
(60) Provisional application No. 60/808,676, filed on May 26, 2006.

(51) Int. Cl. H04R 3/00; H04R 1/02

(52) U.S. Cl. 381/113; 381/91; 333/4

(57) ABSTRACT

An automotive balanced microphone system (300) includes a microphone (303) located in a vehicle mirror (301) connected in a balanced configuration for eliminating noise. A split resistor network (305) is used for supplying a supply voltage to the balanced microphone (303). The split resistor network (305) allows the microphone (303) to be easily powered while noise induced into the supply lines can easily cancelled at the microphone output for use with an electronic device (309).

### CROSS-REFERENCE TO RELATED APPLICATIONS

This application claims the benefit of U.S. Provisional Application No. 60/808,676, filed May 26, 2006, which is hereby incorporated herein by reference in its entirety.

### FIELD OF THE INVENTION

The present invention relates generally to microphone systems and more particularly to a microphone system used in vehicular applications.

### BACKGROUND

Microphones are used in vehicular applications for cellular telephones and/or voice recognition systems. Those skilled in the art will recognize that the microphone might be placed in a rear view mirror or within one or more portable devices integrated into the vehicle. Commonly owned U.S. Pat. Nos. 6,614,911, 6,882,734, 6,980,092, 7,120,261 and U.S. Patent Publication 2004/0208334A1 to Gentex Corporation describe systems having various types of microphone applications and are each herein incorporated by reference.

A design issue when using microphones in such applications occurs with induced vehicular electrical or radio frequency (RF) noise that can be supplied to the input wiring of the microphone. Those skilled in the art will recognize that a conductor exposed to a varying magnetic field will also have a varying current induced into it. Similarly, a conductor exposed to a varying electric field will also have a current induced into it due the intrinsic capacitances between the conductors. In either event, this works to allow electrical noise into the electronic device which degrades performance. In automotive applications, it is not uncommon to have wires used for supplying audio signals to a microphone positioned very close to automotive alternator cable carrying many amperes of charging current. Since this cable can typically carry 50 amperes or more, this type of charging environment can produce a high level of electrical noise that is induced into both the microphone wires and/or the microphone element(s) used in the microphone housing.

One way to reduce these effects is to utilize shielded wire in conjunction with the device's microphone wiring. The shielded wire includes a conductive braided wire and/or foil sheath encircling one or more non-shielded wire conductors that works to reduce these induced noise effects. However, the use of shielded wire can be expensive to use in large quantity and can be limited in its effectiveness. In order to be valuable in reducing noise, the shielding layer must be conductive at all frequencies of importance such that reactive components, which are affected by the size and shape of the shield, are negligible at the desired frequency ranges of the microphone.

Still other methods used to reduce and/or eliminate electrical noise are shown in prior art FIGS. 1 and 2. FIG. 1 illustrates the use of a transformer device 100 that includes a center tapped primary winding 101 such that a supply voltage Vcc is supplied to a microphone via the center tap winding 103. The primary winding inputs 103, 104 connect to microphone 105 to provide the appropriate supply voltage. A resistor or other current limiting device 106 and Zener diode 107 may be used to regulate the supply voltage to the microphone 105. Since the transformer acts to isolate any high frequency noise, the transformer secondary 109 supplies a relatively clean and noise free microphone signal to an output stage 111. The output stage typically is a push-pull amplifier comprised of transistors 113, 115 or the like that supplies audio to an output 117. The drawbacks in using this type of transformer application include both cost and the greater number of discrete elements that can provide an impedance imbalance between the two halves of the center tapped transformer. Any impedance imbalance will cause a decrease in operational efficiency.

Similarly, prior art FIG. 2 illustrates a block diagram of yet another approach for microphone noise elimination as used in the prior art. In this application, a balanced microphone circuit 200 is used to supply a balanced output signal from a microphone 201. The microphone 201 is powered through separate dropping resistors 203, 205 from a supply Vcc. The output of microphone 201 is supplied to a differential amp 207 and then to an output 209. In this prior art embodiment, induced noise is eliminated at the microphone though the use of a balanced output and differential input system. The use of balanced microphone outputs work to balance any induced noise between the two microphone conductors. Additionally, if a “twisted pair” type arrangement is used where the conductors are physically twisted through one or more turns, both conductors are exposed to exactly the same induced noise conditions and will have the same resulting noise cancellation if both conductor ends are terminated in exactly the same manner. Such noise will be common-mode and will be rejected by a differential input.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is schematic diagram illustrating a prior art technique for eliminating noise to a microphone;

FIG. 2 is a block diagram illustrating an alternative prior art technique for eliminating noise to a microphone;

FIG. 3 is a block diagram illustrating the use of an automotive balanced microphone system in accordance with an embodiment of the invention; and

FIG. 4 is a schematic diagram of the automotive balanced microphone system in accordance with an embodiment of the invention.

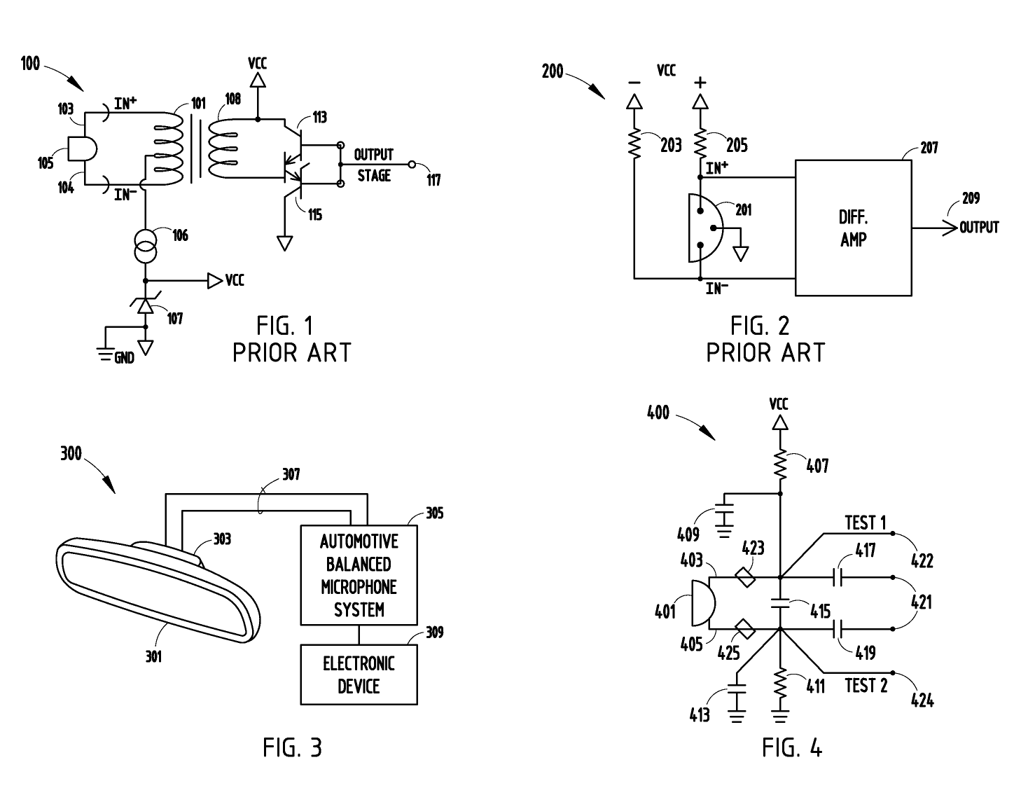

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to an automotive balanced microphone system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

FIG. 3 is a block diagram illustrating the use of an automotive balanced microphone system in accordance with an embodiment to the invention. A vehicular mirror assembly 301 is integrated into and includes one or more microphones 303 that are connected to the microphone system 305 in an electrically balanced configuration as described herein. An electret microphone or similar microphone may be used herein. The electret microphone is a capacitor type microphone that uses a dielectric material that has been permanently electrically charged or polarized where a static charge is embedded in the electret element by alignment of the static charges in the material. Thus automotive balanced microphone system 305 works to cancel noise on its output lines 307 for eliminating and/or canceling unwanted in-phase noise products. In turn, this allows an electronic device 309 to operate effectively in substantially high electrical noise environments which are often present in vehicular and/or automotive applications. The electronic device 309 might include devices such as cellular telephone, Bluetooth transceiver, automotive navigation system or other devices using voice recognition to eliminate and/or reduce electric noise products at the microphone 303.

FIG. 4 is a schematic diagram illustrating a balanced automotive microphone system in accordance with an embodiment of the present invention. The balanced automotive microphone system 400 includes a microphone 401 having a pair of supply lines 403, 405 that work to supply voltage to the device as well as providing an output audio signal. The supply line 403 connects to a supply voltage Vcc through supply resistor 407. A bypass capacitor 409 is connected to the inner side of the supply resistor 407 in order to shunt any radio frequency (RF) energy present on the supply line to ground. Similarly, supply resistor 411 connects from the supply line 405 to ground. A bypass capacitor 413 is also used on the inner side of resistor 411 to ground to shunt RF energy present on supply line 405 to ground.

A third bypass capacitor 415 connects between supply line 401 and supply line 405 to couple RF energy between the supply lines while blocking the DC voltage supplied by Vcc. Coupling capacitors 417, 419 couple the audio produced by the microphone 401 to a balanced output 421. One or more ferrite beads 423, 425 can be used on the supply lines 403, 405 to further block or “choke” the RF energy from reaching the microphone 301. Finally, a first test point 422 is also used at the junction of bypass capacitor 415 and coupling capacitor 417. The first test point 424 is used for quickly determining the operational status of the first portion of the balanced microphone system 400 namely those components on a first side of the balanced microphone 401. This test might be performed using either voltage, resistance and/or impedance measurements. Similarly, a second test point 424 is used at the junction of the bypass capacitor 413, resistor 411 and bypass capacitor 415 to also provide an access point for testing the operational status of a second portion of the balanced automotive microphone system 400 namely those components on the second side of balanced microphone 401.

Hence, an embodiment of the present invention provides that the balanced audio connection includes two wires, each having an inverted polarity to the other. The received signal at output 421 is between these two signal lines. This signal recombination can be difference implemented with a differential amplifier where the negated signal is tied to the negative terminal of an operational amplifier (not shown). A balanced-to-unbalanced transformer (balun) (not shown) may also be used instead of an active differential amplifier device. Much of the noise induced in any input cable is induced equally in both signal lines, so this noise can be easily rejected. The noise received in the second, inverted signal line is applied against the first signal line where it is cancelled out when the two output signals are mathematically subtracted. Accordingly, in a differential stage any noise coupled to both lines having the same phase will be eliminated.

It should be evident that any noise currents induced into a balanced audio line will not therefore be directly modulated onto the signal unlike that of a two-conductor unbalanced system. In practical automotive use, if a device such as a cellular telephone or navigation system is located at any distance from a mirror unitizing the balanced microphone system 400, it is also normal to use balanced lines for these signal paths.

Thus an embodiment of the present invention is directed to a balanced automotive microphone system 400 that includes a split load resistor configuration for supplying voltage to a balanced microphone 401. A split load resister configuration is defined has a resistive load, using one of more resistors, on a portion, branch or “leg” of supply lines 403, 405. The split resistor configuration allows the microphone to be easily powered while noise induced into the supply lines 403, 405 can be easily cancelled at the microphone output 421.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. Some or all functions of the invention may be implemented by a state machine that has no stored program instructions, or in one or more application specific integrated circuits (ASICs), in which each function or some combination of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. An automotive balanced microphone system comprising:
at least one microphone located in a vehicle mirror connected in a balanced configuration for eliminating noise; and
a split resistor network for supplying a supply voltage to the at least one balanced microphone.

2. An automotive balanced microphone system as in claim 1, wherein the split resistor network is comprised of a plurality of resistor sections.

3. An automotive balanced microphone system as in claim 2, wherein the plurality of resistor sections have substantially the same resistance.

4. An automotive balanced microphone system as in claim 1, wherein the split resistor network includes at least one predetermined test point.

5. An automotive balanced microphone system as in claim 1, further comprising at least one bypass capacitor for shunting radio frequency (RF) energy from the split resistor network to ground.

6. A balanced microphone system for use in a vehicle comprising:
at least one microphone connected in an electrically balanced configuration;
a resistor network having a plurality of resistive sections for supplying a voltage to the at least one microphone; and
at least one coupling capacitor for coupling the output of the at least one microphone to an electronic device.

7. A balanced microphone system for use in a vehicle as in claim 6, further comprising:
a predetermined test point common the resistive network for determining the operational status of the mirror system.

8. A balanced microphone system for use in a vehicle as in claim 6, wherein the resistive sections have substantially the same resistance.

9. A balanced microphone system for use in a vehicle as in claim 6, further comprising at least one bypass capacitor positioned across the output of the microphone.

10. A balanced microphone system for use in a vehicle as in claim 6, further comprising at least one bypass capacitor for shunting radio frequency (RF) energy from the plurality of resistive sections to ground.

11. A balanced microphone system for use in a vehicle as in claim 6, further comprising at least one ferrite choke for preventing radio frequency (RF) energy from being provided to the input of the at least one microphone.

12. A method for forming an automotive microphone system comprising the steps of:
configuring at least one microphone with an electrically balanced output;
supplying a voltage to the at least one microphone using a split resistor network; and
configuring the split resistor network such that it has a plurality of legs.

13. A method for forming an automotive microphone system as in claim 12, further comprising the step of:
establishing a value for the plurality of legs such that they are substantially equal.

14. A method for forming an automotive microphone system as in claim 12, further comprising the step of:
blocking radio frequency (RF) energy from entering the at least one microphone input using at least one choke.

15. A method for forming an automotive microphone system as in claim 14, wherein the at least one choke is a ferrite bead.

16. A method for forming an automotive microphone system as in claim 12, further comprising the step of:
forming a predetermined test point at the plurality of legs of the resistive network for testing the operational status of the automotive microphone system.

17. A method for forming an automotive microphone system as in claim 12, further comprising the step of:
connecting at least one bypass capacitor to the split resistor network for shunting radio frequency (RF) energy to ground.
